(19) United States
(12) Patent Application Publication
(10) Pub. No.: US 2005/0144338 A1
(43) Pub. Date: Jun. 30, 2005

(54) Data transfer apparatus

(75) Inventor: Yasuhiro Yamazaki, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/064,097

(22) Filed: Feb. 24, 2005

Related U.S. Application Data
(63) Continuation of application No. PCT/JP03/02270, filed on Feb. 27, 2003.

(51) Int. Cl. G06F 3/00

(52) U.S. Cl. 710/29

(57) ABSTRACT

A data transfer apparatus is provided that can achieve high-speed data transfer by operating according to a double-buffer method as need arises while normally operating according to a single-buffer method. The data transfer apparatus includes a first channel unit configured to perform first data transfer in a first operation mode by using a first buffer as a relay, and a second channel unit configured to perform second data transfer different from the first data transfer in the first operation mode by using a second buffer as a relay, wherein a plurality of buffers including at least the first buffer and the second buffer are successively selected in a second operation mode so as to transfer data read from a source to a destination by using the successively selected buffers as relays, the reading of the data from the source being performed concurrently with writing of the data to the destination.

### CROSS-REFERENCE TO RELATED APPLICATION

This is a continuation of International Application No. PCT/JP2003/002270, filed on Feb. 27, 2003, the entire contents of which are hereby incorporated by reference.

### BACKGROUND OF THE INVENTION

1. Field of the Invention

The present invention generally relates to data transfer apparatuses, and particularly relates to a data transfer apparatus that performs DMA transfer of data in a dual-bus system.

2. Description of the Related Art

In computer systems, DMA (Direct Memory Access) transfer is an indispensable technology for attaining high system performance. The DMA transfer achieves direct data transfer between two devices without an intervention from the CPU.

Computer systems are generally comprised of a plurality of devices and a bus connecting therebetween. The devices connected to the bus are classified into master devices that transmit Read or Write requests and slave devices that receive these requests transmitted from the masters. The DMAC (DMA controller) that controls DMA (Direct Memory Access) and the CPU are master devices that transmit requests.

The DMAC performs data transfer between slave devices without an intervention from the CPU. In bus systems, addresses are used to identify individual slave devices and also to identify positions within the individual slave devices (e.g., individual addresses within a memory device). FIG. 1 is an address map showing allocation of slave devices in address space.

A DMAC transmits a Read request to a slave device to read information from a specified position within the slave device specified by the address. The DMAC then transmits a Write request to transfer the retrieved information to another slave device. In this manner, the DMAC transmits Read and Write requests so as to achieve data transfer between the slave devices.

FIG. 2 is a drawing for explaining data transfer operations of a double-buffer method in a dual-bus system.

The dual-bus system of FIG. 2 includes a DMAC 10, a bus 11, a bus 12, a RAM 13, a ROM 14, a video display 15, and a UART (Universal Asynchronous Receiver Transmitter) 16. The DMAC 10 is a master device, and the RAM 13, the ROM 14, the video display 15, and the UART 16 are slave devices. The RAM 13 and the ROM 14 are coupled to the DMAC 10 via the bus 11. The video display 15 and the UART 16 are coupled to the DMAC 10 via the bus 12.

The DMAC 10 includes two buffers (Buffer1) 21 and (Buffer2) 22. In the following, a DMA data transfer operation from the RAM 13 to the video display 15 will be described as an example. FIG. 3 is a timing chart showing a DMA data transfer operation from the RAM 13 to the video display 15.

The DMAC 10 transmits a Read request to the RAM 13, and stores data in the buffer 21 as the data is supplied from the RAM 13 as a result of the Read request. This Read operation is shown as RAM->buffer1 in FIG. 3. After the completion of the Read operation, the DMAC 10 writes the information stored in the buffer 21 to the video display 15. This Write operation is shown as buffer1->video in FIG. 3.

Since the configuration of FIG. 2 is based on a double-buffer method, another buffer (buffer2) 22 can be used simultaneously with the buffer 21. That is, concurrently with writing from the buffer 21 to the video display 15, next data is read from the RAM 13 for storage in the buffer 22 (RAM->buffer2). The data stored in the buffer 22 is written to the video display 15 (buffer2->video) concurrently with reading of data from the RAM 13 for storage in the buffer 21.

In this manner, a data transfer based on the double-buffer method in the dual-bus system utilizes two busses and two buffers, thereby attaining a transfer rate between slave devices that is twice as fast as that of a single-buffer method utilizing a single buffer.

The double-buffer method as described above needs to store twice as much information as that stored in the single-buffer method, resulting in increased consumption of chip areas. Moreover, in general, not many of the slave devices provided in the system require such high transfer performance as high as that attained by use of the double-buffer method. The double-buffer method thus can be meritorious because of its high data transfer performance only in limited cases while the demerit of needing an increased chip area is always in existence.

In consideration of this, the present invention is aimed at providing a data transfer apparatus that can achieve high-speed data transfer by operating according to a double-buffer method as need arises while normally operating according to a single-buffer method.

Patent Document 1: Japanese Patent Application Publication No. 1-229353

Patent Document 2: Japanese Patent Application Publication No. 64-78351

### SUMMARY OF THE INVENTION

The data transfer apparatus according to the present invention includes a first channel unit configured to perform first data transfer in a first operation mode by using a first buffer as a relay, and a second channel unit configured to perform second data transfer different from the first data transfer in the first operation mode by using a second buffer as a relay, wherein a plurality of buffers including at least the first buffer and the second buffer are successively selected in a second operation mode so as to transfer data read from a source to a destination by using the successively selected buffers as relays, the reading of the data from the source being performed concurrently with writing of the data to the destination.

In the data transfer apparatus as described above, each channel operates as a separate channel to perform a separate data transfer in the first operation mode when there is no need for high-speed data transfer. When high-speed data transfer becomes necessary, data reading and data writing are concurrently performed in the second operation mode, thereby achieving a double-buffer-method data transfer. Accordingly, efficient data transfer is achieved by a plurality of channels performing single-buffer methods when there is no need for high-speed data transfer, while high-speed data transfer is achieved by a single channel performing a double-buffer method when there is a need for high-speed data transfer. With this provision, it is thus possible to take an advantage of the high-speed data transfer of a double-buffer method while reducing the demerits of the double-buffer method.

### BRIEF DESCRIPTION OF THE DRAWINGS

Other objects and further features of the present invention will be apparent from the following detailed description when read in conjunction with the accompanying drawings; in which:

FIG. 1 is an address map showing allocation of slave devices in address space;

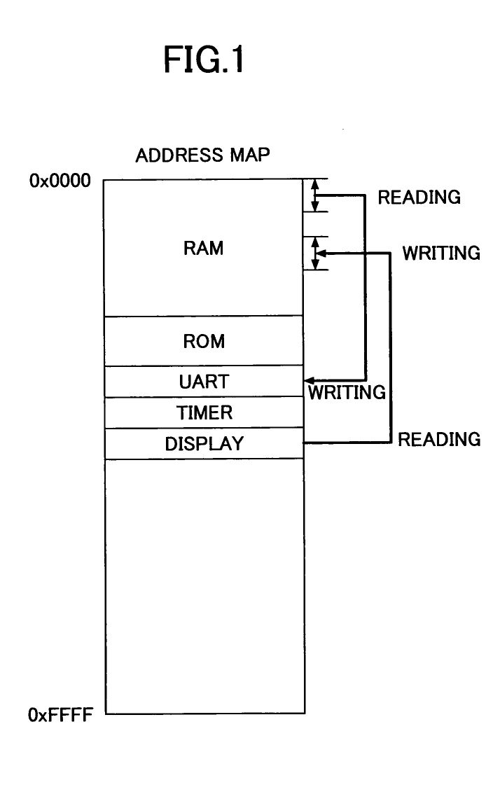

FIG. 2 is a drawing for explaining data transfer operations of a double-buffer method in a dual-bus system;

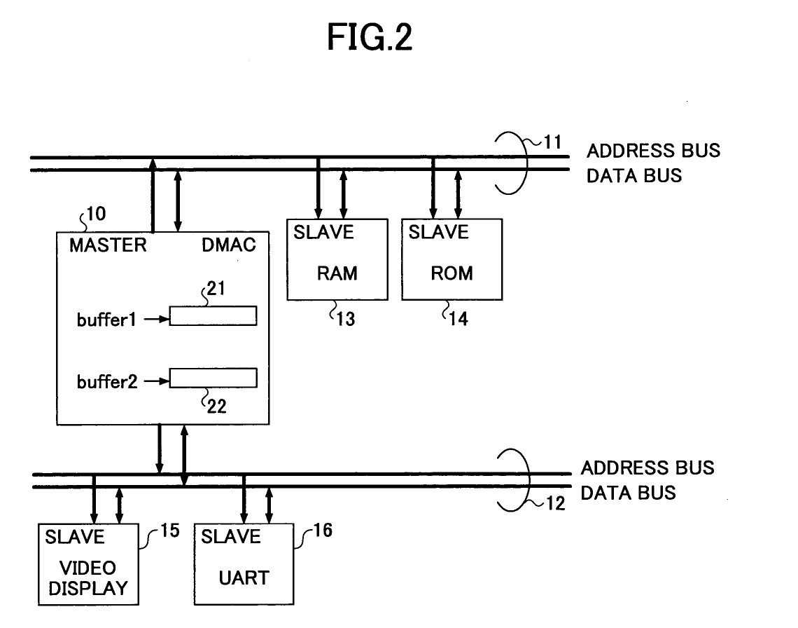

FIG. 3 is a timing chart showing a DMA data transfer operation from a RAM to a video display;

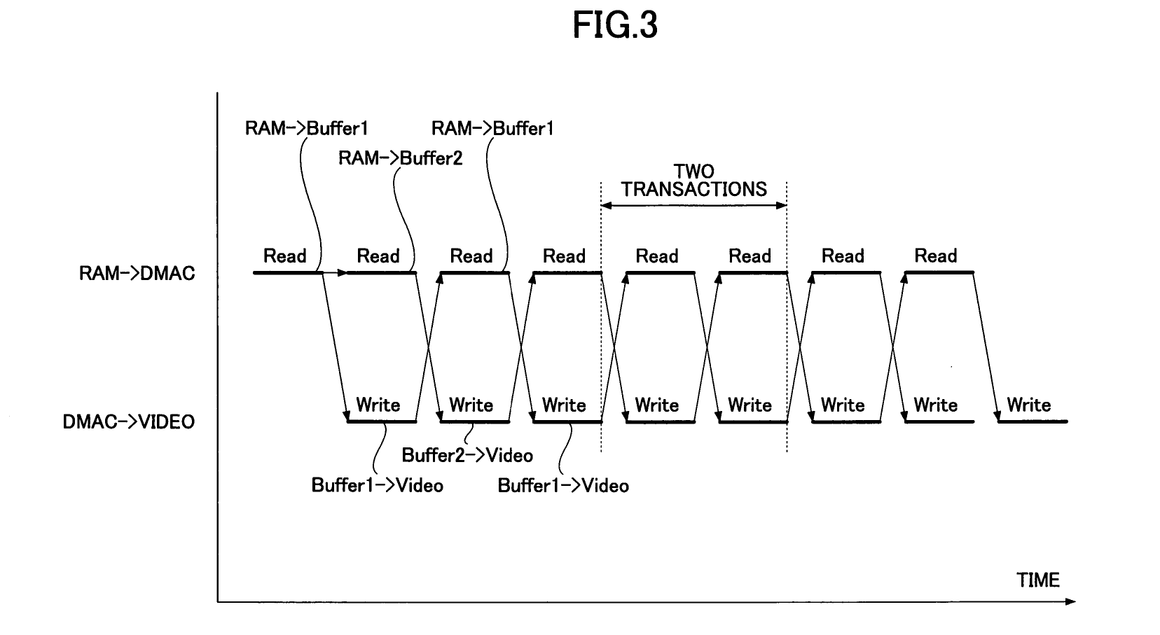

FIG. 4 is a drawing for explaining a DMA controller (data transfer apparatus) according to the present invention;

FIG. 5 is a timing chart showing a double-buffer-method data transfer operation from a RAM to a video display;

FIG. 6 is a drawing for explaining operations for performing DMA data transfer from the RAM to a UART via a first channel and performing DMA data transfer from the RAM to the video display via a second channel;

FIG. 7 is a timing chart showing data transfer operations performed by the two channels shown in FIG. 6;

FIG. 8 is a drawing showing an embodiment of the construction for achieving a double-buffer-method data transfer by letting two channels operate as a single channel;

FIG. 9 is a timing chart showing a data transfer operation of FIG. 8;

FIG. 10 is a drawing showing another embodiment of the construction for achieving a double-buffer-method data transfer by letting two channels operate as a single channel;

FIG. 11 is a timing chart showing a data transfer operation of FIG. 8;

FIG. 12 is a drawing for explaining another embodiment of high-speed data transfer according to the present invention; and

FIG. 13 is a timing chart showing a double-buffer-method data transfer operation from the RAM to the video display.

### DESCRIPTION OF THE PREFERRED EMBODIMENTS

In the following, embodiments of the present invention will be described with reference to the accompanying drawings.

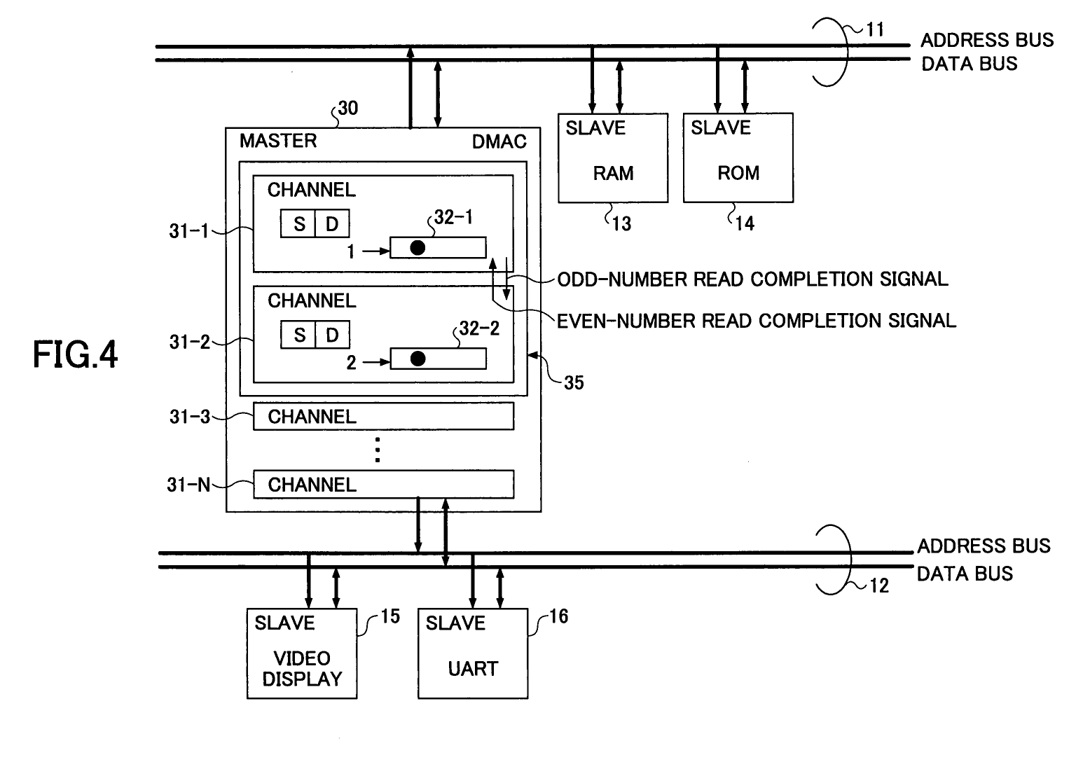

FIG. 4 is a drawing for explaining a DMA controller (data transfer apparatus) according to the present invention.

A DMA controller (DMAC) 30 according to the present invention is used in a dual-bus system as shown in FIG. 4. A bus system of FIG. 4 includes the DMAC 30, a bus 11, a bus 12, a RAM 13, a ROM 14, a video display 15, and a UART 16. The RAM 13 and the ROM 14 are coupled to the DMAC 30 via the bus 11. The video display 15 and the UART 16 are coupled to the DMAC 30 via the bus 12.

The DMAC 30 has a plurality of channels (channel units) 31-1 through 31-N implemented therein, with each channel provided with a buffer. For example, the channel 31-1 is provided with a buffer 32-1, and the channel 31-2 is provided with a buffer 32-2. Each channel of the DMAC is provided with two registers S and D for address settings. The register S stores an address indicative of a position within the slave device serving as a source of transfer, and the register D stores an address indicative of a position within the slave device serving as a destination of transfer.

In the example shown in FIG. 4, both the channel 31-1 and the channel 31-2 perform DMA data transfer from the RAM 13 to the video display 15. With this provision, the channel 31-1 and the channel 31-2 operate virtually as a single channel, thereby achieving a double-buffer-method data transfer utilizing the two buffers 32-1 and 32-2.

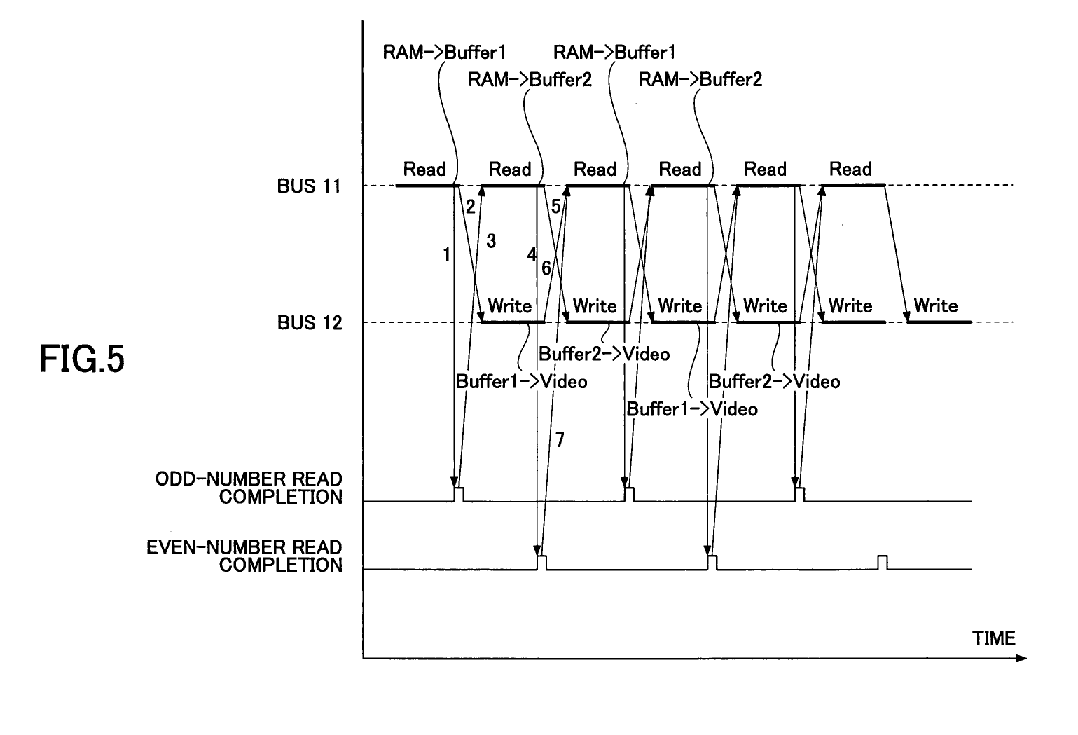

FIG. 5 is a timing chart showing a double-buffer-method data transfer operation from the RAM 13 to the video display 15.

The channel 31-1 of the DMAC 30 transmits a Read request to the RAM 13, and stores data in the buffer 32-1 as the data is supplied from the RAM 13 as a result of the Read request. This Read operation is shown as RAM->buffer1 in FIG. 5. After the completion of the Read operation, the channel 31-1 transmits an odd-number read-completion signal to the channel 31-2 so as to instruct the channel 31-2 to start data transfer (an arrow 1 and arrow 3 shown in FIG. 5). Concurrently with this, the channel 31-1 starts an operation to write the information stored in the buffer 32-1 to the video display 15 (an arrow 2 in FIG. 5). This Write operation is shown as buffer1->video in FIG. 5.

The channel 31-2 detects the assertion of the odd-number read-completion signal to transmit a Read request to the RAM 13. This results in next data being read from the RAM 13 for storage in the buffer 32-2 (RAM->buffer2). This operation is performed concurrently with the operation (buffer1->video) by the channel 31-1 that writes the information stored in the buffer 32-1 to the video display 15. After the completion of transfer from the RAM 13 to the buffer 32-2, the channel 31-2 transmits an even-number read-completion signal so as to instruct the channel 31-1 to start a data transfer (arrows 4 and 7 in FIG. 5). In response to the completion of writing (an arrow 6) and the assertion of the even-number read-completion signal (an arrow 7), the channel 31-1 transmits a next Read request to the RAM 13 to start a read operation.

Concurrently with the reading of data by the channel 31-1 from the RAM 13 for storage in the buffer 32-1 (RAM->Buffer1), the channel 31-2 writes the data stored in the buffer 32-2 to the video display 15 (buffer2->video).

In this manner, the two channels alternatively use their own buffers to operate virtually as a single channel, thereby achieving a double-buffer-method data transfer. This achieves high transfer performance as such need arises.

Round Robin scheduling or rotation priority scheduling may be used as priority control for determining which channel is selected for transfer via the bus. In such a case, the data transfer as described above that utilizes two channels as one channel can acquire priority twice as often as data transfers by other channels. This thus provides an advantage in that double the transfer rate is attainable without exception when data transfer is required for the slave devices that need a higher transfer rate.

The DMAC 30 shown in FIG. 4 performs a double-buffer-method data transfer by letting two channels operate virtually as a single channel as such need arises. When there is no need for high-speed data transfer, each channel serves as a separate channel to perform an individual data transfer operation.

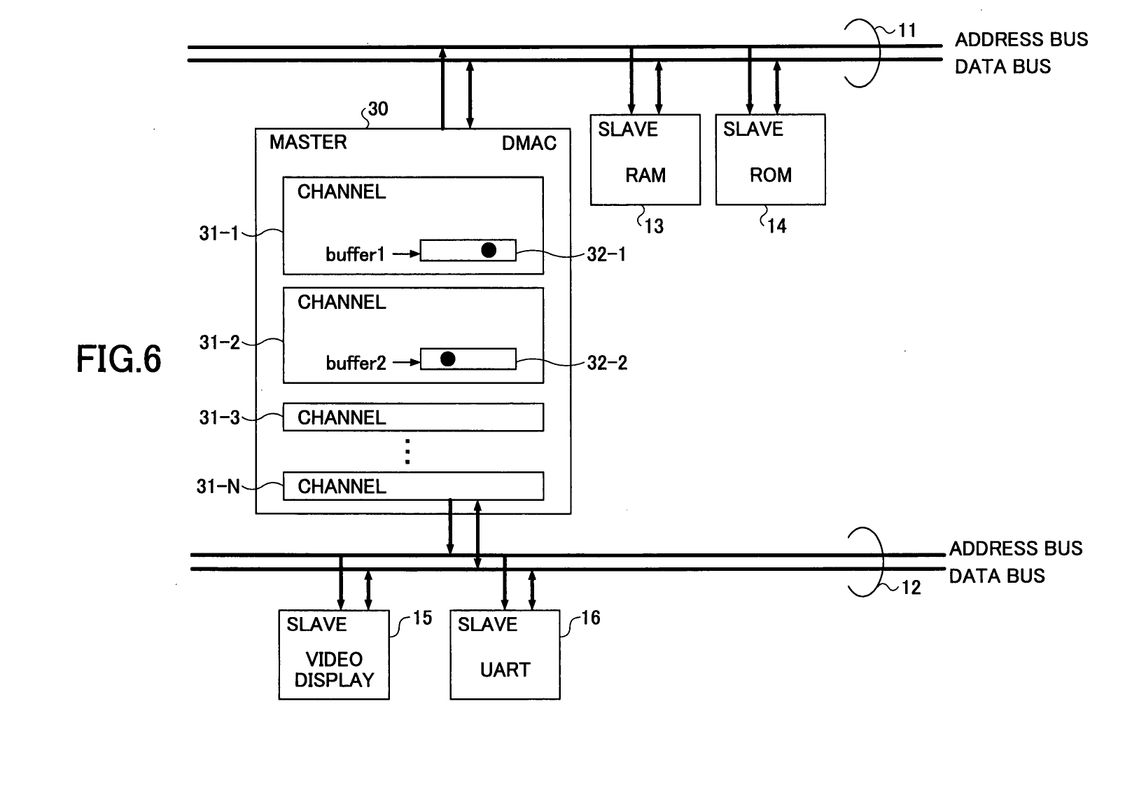

FIG. 6 is a drawing for explaining operations for performing DMA data transfer from the RAM 13 to the UART 16 via the channel 31-1 and performing DMA data transfer from the RAM 13 to the video display 15 via the channel 31-2.

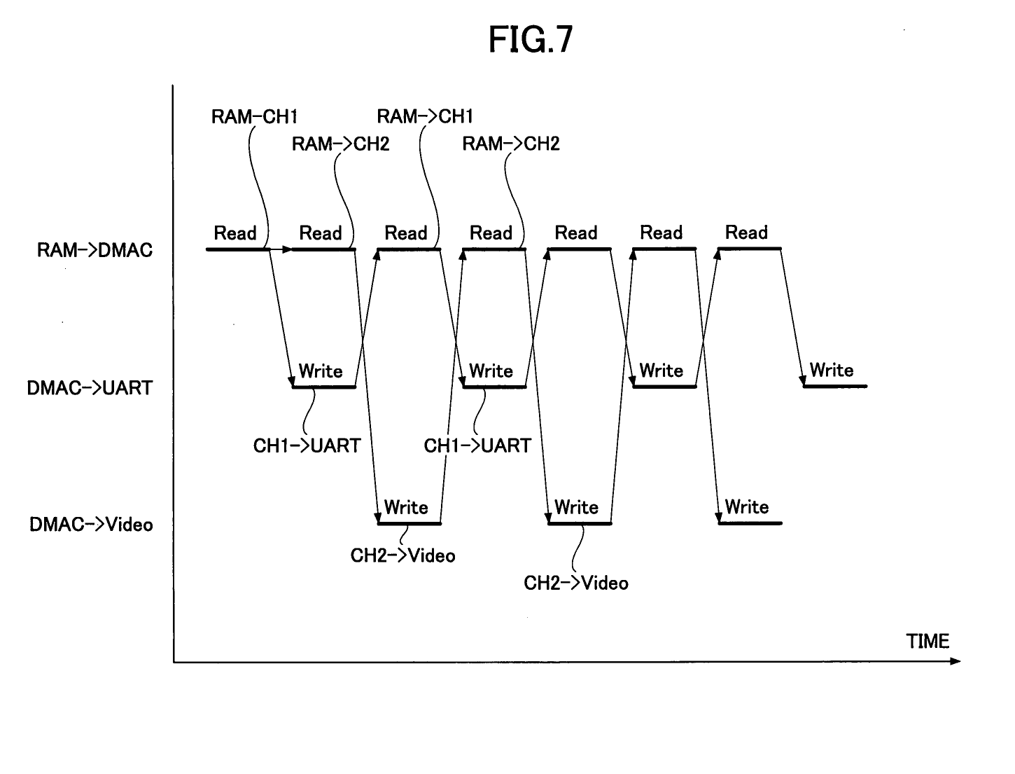

FIG. 7 is a timing chart showing data transfer operations performed by the two channels shown in FIG. 6.

The channel 31-1 of the DMAC 30 transmits a Read request to the RAM 13, and stores the information obtained as a result of the Read request in the buffer 32-1 of the channel 31-1 (RAM->CH1). The channel 31-1 then transmits a Write request to the UART 16 to write the contents of the buffer 32-1 to the UART 16 (CH1->UART).

Concurrently with writing by the channel 31-1 to the UART 16, the channel 31-2 transmits a Read request to the RAM 13 to store the retrieved information in the buffer 32-2 (RAM->CH2). The channel 31-2 then writes the contents of the buffer 32-2 to the video display 15 (CH2->Video).

In this manner, each channel operates as a separate channel to perform an individual data transfer when high-speed data transfer is not needed. If high-speed data transfer becomes necessary, two channels operate virtually as a single channel as previously described, thereby performing a double-buffer-method data transfer. Accordingly, efficient data transfer is achieved by a plurality of channels performing single-buffer methods when there is no need for high-speed data transfer, while high-speed data transfer is achieved by a single channel performing a double-buffer method when there is a need for high-speed data transfer. With this provision, it is thus possible to take an advantage of the high-speed data transfer of a double-buffer method while reducing the demerits of the double-buffer method.

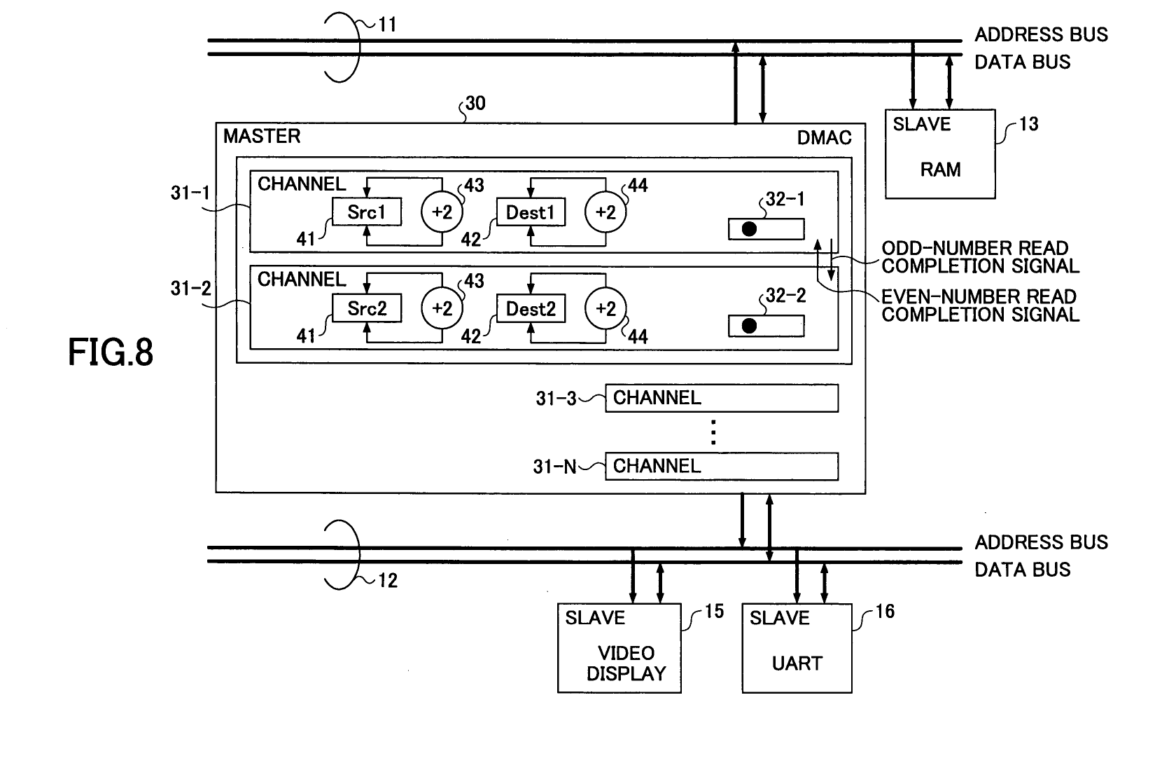

FIG. 8 is a drawing showing an embodiment of the construction for achieving a double-buffer-method data transfer by letting two channels operate as a single channel.

In FIG. 8, the DMAC 30 has the plurality of channels 31-1 through 31-N implemented therein, with each channel provided with a buffer. Each channel is provided with a transfer-source register 41, a transfer-destination register 42, an address increment module 43, and an address increment module 44. The transfer-source register 41 stores the address of the source of data transfer performed by the channel, and the transfer-destination register 42 stores the address of the destination of data transfer performed by the channel. The address increment module 43 updates the content of the transfer-source register 41 by adding 2 thereto. The address increment module 44 updates the content of the transfer-destination register 42 by adding 2 thereto.

The DMAC performs data transfer by incrementing the transfer-source address and the transfer-destination address. Normally, the addresses are incremented (+1) by the size of transfer data that is read or written by a single buffer transfer operation. In the embodiment shown in FIG. 8, on the other hand, the two channels increment (+2) the addresses by twice the size of transfer data.

In the construction of this embodiment, a double-buffer operation is achieved by slight modification to the address increment modules with almost no change to the construction of the controller for controlling the buffers. It should be noted that the address increment modules are configured such as to be able to switch between a +1 increment and a +2 increment so that it can provide +1 address increment to conform also to a single-buffer-method data transfer.

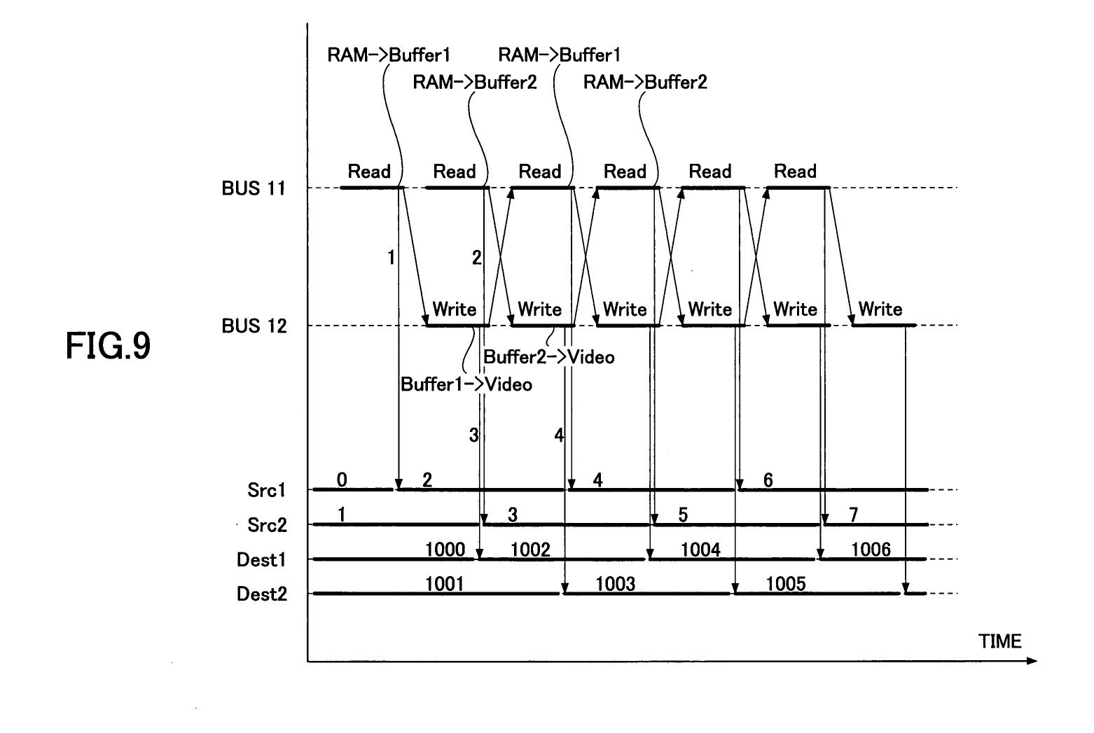

FIG. 9 is a timing chart showing a data transfer operation of FIG. 8.

The content of the transfer-source register 41 of the channel 31-1 is denoted as Src1, and the content of the transfer-destination register 42 of the channel 31-1 is denoted as Dest1. The content of the transfer-source register 41 of the channel 31-2 is denoted as Src2, and the content of the transfer-destination register 42 of the channel 31-2 is denoted as Dest2.

In FIG. 9, the flow of data with respect to reading and writing operations is the same as in FIG. 5. In the following, a description will be given by relating the reading and writing operations to the generation of addresses. First, the channel 31-1 performs a Read operation with respect to an address (0) of Src1 (RAM->Buffer1). In response to the completion of this Read operation (an arrow 1), Src1 is updated by an outcome (2) that is obtained by adding 2 to Src1. By the same token, the channel 31-2 performs a Read operation with respect to an address (1) of Src2 (RAM->Buffer2) . In response to the completion of this Read operation (an arrow 2), Src2 is updated by an outcome (3) that is obtained by adding 2 to Src2.

Concurrently with the Read operation by the channel 31-2, the channel 31-1 performs a Write operation (Buffer1->Video) with respect to an address (1000) of Dest1. In response to the completion of the Write operation by the channel 31-1 (an arrow 3), Dest1 is updated by an outcome (1002) that is obtained by adding 2 to Dest1. By the same token, in response (an arrow 4) to the completion of the Write operation (Buffer2->Video) by the channel 31-2, Dest2 is updated by an outcome (1003) that is obtained by adding 2 to Dest2.

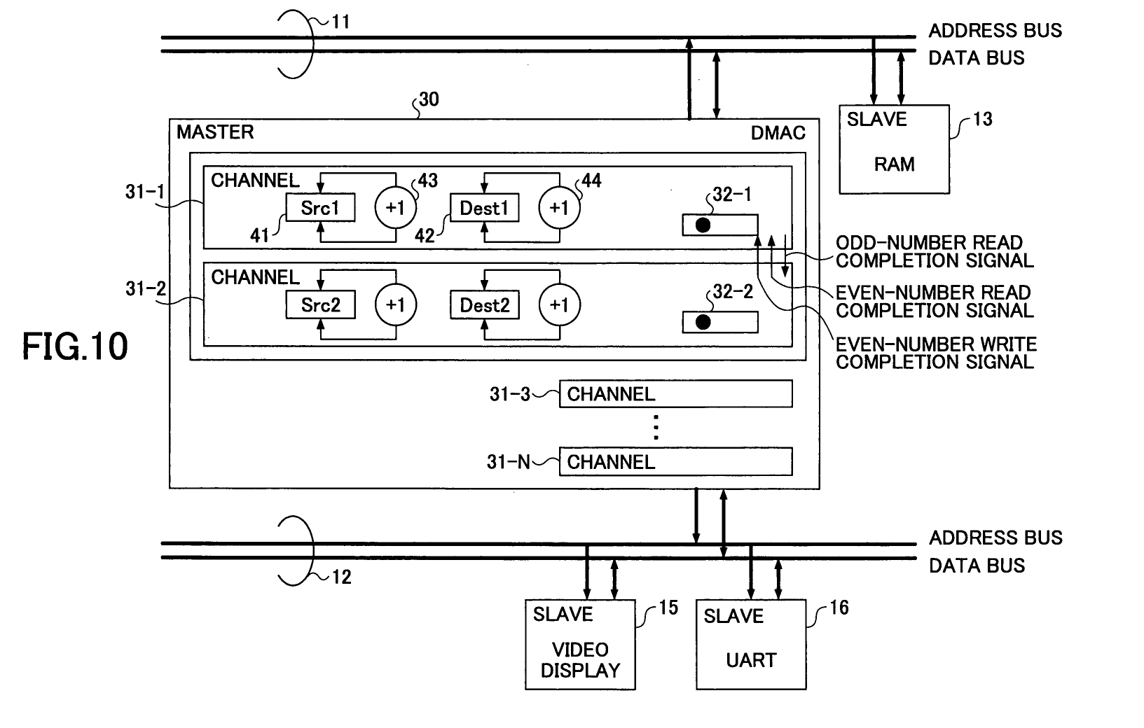

FIG. 10 is a drawing showing another embodiment of the construction for achieving a double-buffer-method data transfer by letting two channels operate as a single channel. In FIG. 10, the same elements as those of FIG. 8 are referred to by the same numerals, and a description thereof will be omitted.

The embodiment of FIG. 10 is configured such that only the channel 31-1 transmits addresses. Accordingly, the address increment module 43 updates the content of the transfer-source register 41 by adding 1 thereto, and the address increment module 44 updates the content of the transfer-destination register 42 by adding 1 thereto. Namely, the addresses are incremented (+1) by the size of transfer data that is read or written by a single buffer transfer operation.

In this manner, a double-buffer-method data transfer is achieved by the channel 31-1 and the channel 31-2 using the buffer 32-1 and the buffer 32-2, respectively, while attending to addressing by use of only the transfer-source register 41 and the transfer-destination register 42 of the channel 31-1. In this embodiment, the DMAC 30 needs to be configured such that the channel 31-1 is capable of controlling both of the buffers, but there is no need to provide the address increment module with the mechanism for providing a +2 increment.

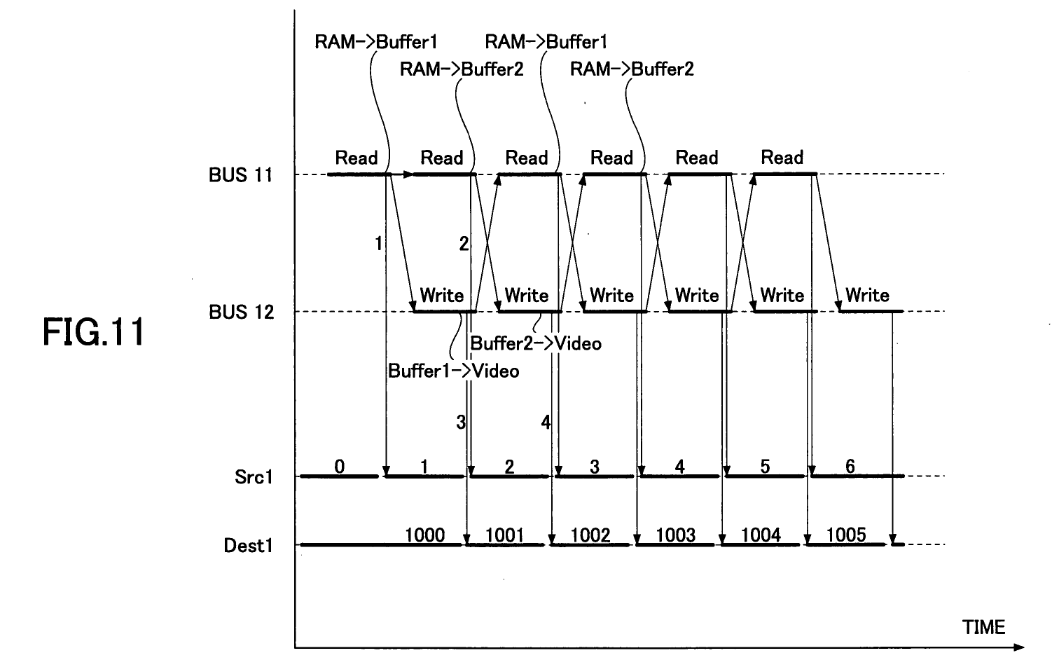

FIG. 11 is a timing chart showing a data transfer operation of FIG. 8.

First, the channel 31-1 performs a Read operation with respect to an address (0) of Src1 (RAM->Buffer1). In response to the completion of this Read operation (an arrow 1), Src1 is updated by an outcome (1) that is obtained by adding 1 to Src1. Then, the channel 31-2 performs a Read operation with respect to an address (1) of Src1 (RAM->Buffer2). In response to its completion (an arrow 2), the channel 31-1 adds 1 to the value of Src1 to update Src1 with the outcome (2) of the addition. This updating may be properly performed in response to an even-number read-completion signal issued from the channel 31-2 to the channel 31-1.

Concurrently with the Read operation by the channel 31-2, the channel 31-1 performs a Write operation (Buffer1->Video) with respect to an address (1000) of Dest1. In response to the completion of the Write operation by the channel 31-1 (an arrow 3), Dest1 is updated by an outcome (1001) that is obtained by adding 1 to the value of Dest1. After this, in response to the completion of the Write operation (Buffer2->Video) by the channel 31-2, the channel 31-2 transmits an even-number write-completion signal to the channel 31-1. In response to the assertion of this even-number write-completion signal (an arrow 4), the channel 31-1 adds 1 to the value of Dest1 to update Dest1 with the outcome (1002) of the addition.

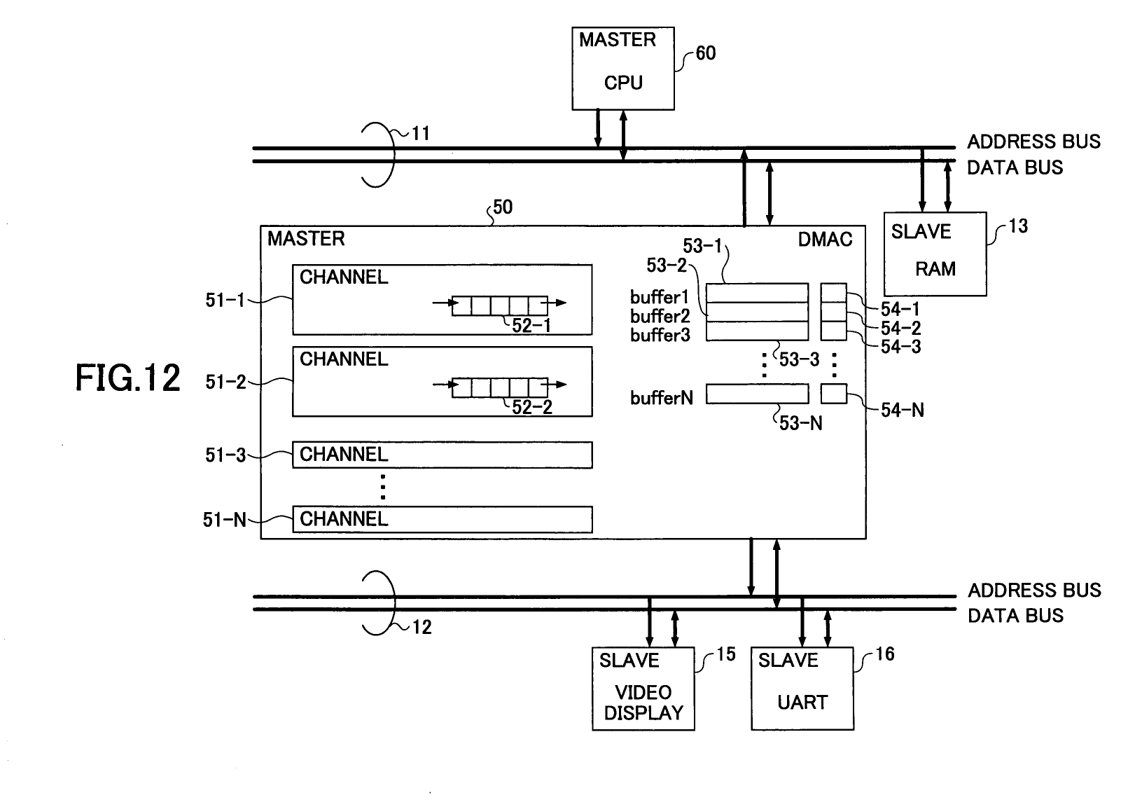

FIG. 12 is a drawing for explaining another embodiment of high-speed data transfer according to the present invention.

A DMA controller (DMAC) 50 according to the present invention is used in a dual-bus system as shown in FIG. 12. The bus system of FIG. 12 includes the DMAC 50, a bus 11, a bus 12, a RAM 13, a video display 15, a UART 16, and a CPU 60. The RAM 13 is coupled to the DMAC 50 via the bus 11. The video display 15 and the UART 16 are coupled to the DMAC 50 via the bus 12.

The DMAC 50 has a plurality of channels (channel units) 51-1 through 51-N implemented therein, with each channel provided with a buffer-sequence-number queue. For example, the channel 51-1 is provided with a buffer-sequence-number queue 52-1, and the channel 51-2 is provided with a buffer-sequence-number queue 52-2. Separate from each channel, buffers 53-1 through 53-N are also provided. Further, validity flags 54-1 through 54-N are provided to indicate whether the respective buffers 53-1 through 53-N are available.

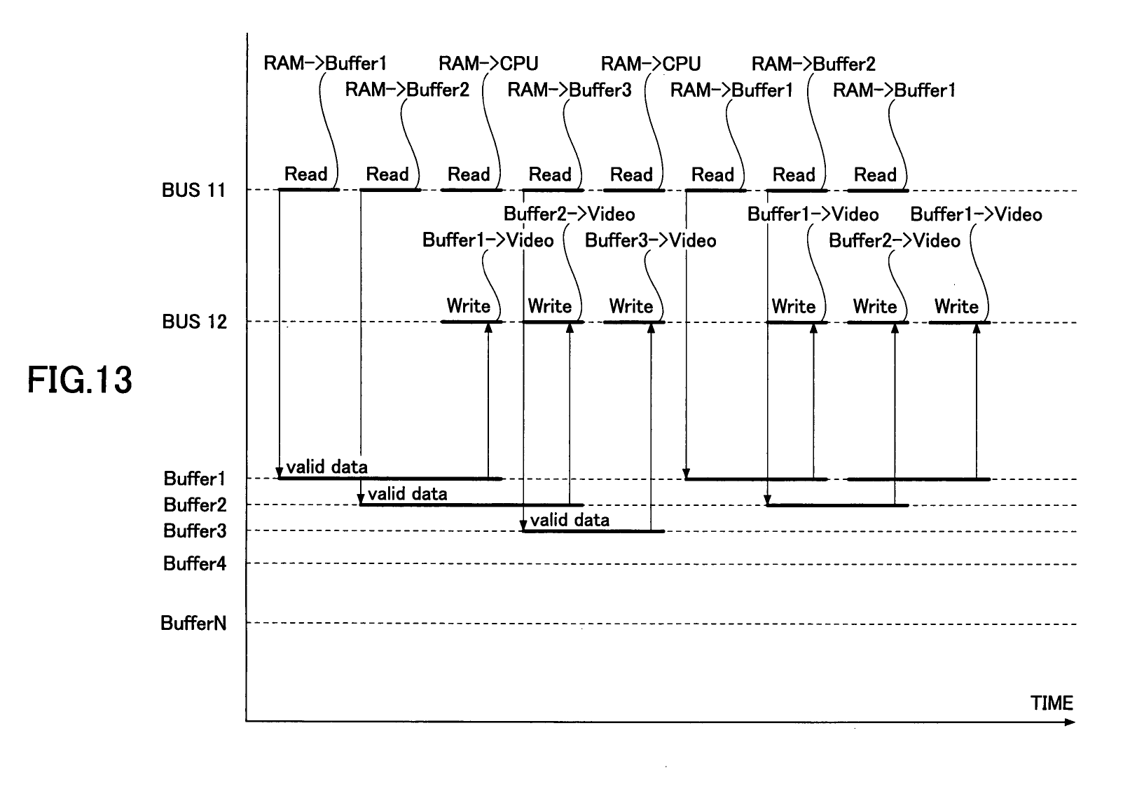

FIG. 13 is a timing chart showing a high-speed data transfer operation from the RAM 13 to the video display 15.

First, the channel 51-1 checks the validity flags 54-1 through 54-N to find an available buffer, and stores the sequence number (Buffer1) of this buffer in the buffer-sequence-number queue 52-1. Further, the channel 51-1 stores the data read from the RAM 13 in the above-noted buffer (i.e., the buffer having the sequence number at the end of the queue) (RAM->Buffer1). Then, the channel 51-1 checks the validity flags 54-1 through 54-N to find an available buffer, and stores the sequence number (Buffer2) of this buffer in the buffer-sequence-number queue 52-1. Further, the channel 51-1 stores the next data read from the RAM 13 in the above-noted buffer (i.e., the buffer having the sequence number at the end of the queue) (RAM->Buffer2).

When a write request arrives from the video display 15, the channel 51-1 writes to the video display 15. At this time, the data is transmitted (Buffer1->Video) to the video display 15 from the buffer indicated by the sequence number that is output from the buffer-sequence-number queue 52-1 (i.e., the sequence number at the head of the queue). As shown in FIG. 13, the channel 51-1 may perform the reading of data from the RAM 13 and the writing of data to the video display 15 concurrently with each other.

In the example of FIG. 13, the channel 51-1 uses Buffer1 again after the successive use of Buffer1, Buffer2, and Buffer3 as buffers, and then uses Buffer2 again, followed by further use of Buffer1. In the data transfer according to this embodiment, the validity flags are checked to identify an available buffer on an as-needed basis, so that the buffer to be used varies depending on the situations.

Moreover, each channel may perform an individual data transfer operation by acquiring a buffer for its own use.

In the embodiment described above, the plurality of buffers are managed collectively, and each channel acquires a buffer on an as-needed basis. In this method, buffer control becomes more complex than in the system shown in FIG. 8 or FIG. 10. If two buffers are available, however, the same advantage as in the double-buffer-method data transfer can be achieved.

More than two buffers are also usable if they are available. Because of this, even if transfer from the transfer source to the DMAC 50 is interrupted halfway through the data transfer due to an interruption such as an access from another master, it is possible to continue transmitting data stored in the plurality of buffers to the transfer destination. For example, access from the CPU 60 to the RAM 13 (RAM->CPU) may be performed multiple times as shown in FIG. 13, causing interruptions to the transfer of data from the RAM 13 to the DMAC 50. Even in such a case, it is possible to lower the possibility of the transfer of data to the video display 15 being interrupted.

The construction of this embodiment has a problem in that if a given channel takes up all the buffers for its own use, another channel cannot perform a Read transfer. In many cases, generally, it is required that the operation from a transfer request to the receipt of data be performed within a predetermined time limit. In order to obviate the problem described above, a straightforward solution is to perform such control operation that each channel is provided with a single corresponding buffer. In this case, it becomes essentially the same as the operation of FIG. 4 and FIG. 6.

Although the present invention has been described with reference to embodiments, the present invention is not limited to these embodiments. Various variations and modifications may be made without departing from the scope of the claimed invention.

1. A data transfer apparatus, comprising:
a first channel unit configured to perform first data transfer in a first operation mode by using a first buffer as a relay; and
a second channel unit configured to perform second data transfer different from the first data transfer in the first operation mode by using a second buffer as a relay,
wherein a plurality of buffers including at least the first buffer and the second buffer are successively selected in a second operation mode so as to transfer data read from a source to a destination by using the successively selected buffers as relays, the reading of the data from the source being performed concurrently with writing of the data to the destination.

2. The data transfer apparatus as claimed in claim 1, wherein the first buffer and the second buffer are alternately selected in the second operation mode so as to transfer data read from the source to the destination by using the alternately selected buffers as relays, the reading of the data from the source to the first buffer being performed concurrently with writing of the data from the second buffer to the destination, and the reading of the data from the source to the second buffer being performed concurrently with writing of the data from the first buffer to the destination.

3. The data transfer apparatus as claimed in claim 2, wherein the first channel and the second channel cooperate in the second operation mode so as to perform data transfer as a single channel.

4. The data transfer apparatus as claimed in claim 3, wherein the first channel and the second channel notifies each other of completion of reading in response to completion of data reading from the source in the second operation mode.

5. The data transfer apparatus as claimed in claim 4, wherein each of the first channel unit and the second channel unit includes:
a source register operable to store an address indicative of an access position where the source is accessed;
a destination register operable to store an address indicative of an access position where the destination is accessed;
a first address increment module configured to increment the address stored in the source register; and
a second address increment module configured to increment the address stored in the destination register,
wherein in the second operation mode, said first address increment module increments the address such as to access every other access position of the source, and said second address increment module increments the address such as to access every other access position of the destination, such that the source register and destination register of the first channel unit and the source register and destination register of the second channel unit indicate the respective access positions alternately.

6. The data transfer apparatus as claimed in claim 4, wherein each of the first channel unit and the second channel unit includes:
a source register operable to store an address indicative of an access position where the source is accessed;
a destination register operable to store an address indicative of an access position where the destination is accessed;
a first address increment module configured to increment the address stored in the source register; and
a second address increment module configured to increment the address stored in the destination register,
wherein in the second operation mode, the first address increment module of the first channel increments the address such as to access the access position of the source one by one in sequence, and the second address increment module of the first channel increments the address such as to access the access position of the destination one by one in sequence, such that data transfer is achieved by the source register and destination register of the first channel unit indicating the respective access positions.

7. The data transfer apparatus as claimed in claim 6, wherein said second channel unit notifies said first channel unit of completion of writing in response to completion of data writing to the destination.

8. The data transfer apparatus as claimed in claim 1, wherein the first channel unit includes a first queue operable to store information items for identifying buffers in sequence, and the second channel unit includes a second queue operable to store information items for identifying buffers in sequence, and wherein in the second operation mode, the first channel unit successively selects available buffers from said plurality of buffers to store information items for identifying the selected buffers successively in the first queue, reading of data from the source to a buffer indicated by a last information item in the first queue being performed concurrently with writing of data from a buffer indicated by a first information item in the queue to the destination.

9. A data transfer apparatus, comprising:
a first channel unit; and
a second channel unit,
wherein said first channel unit includes:
a first buffer,
a first source register to indicate an access position where a source is accessed;
a first destination register to indicate an access position where a destination is accessed, said first channel unit configured to transfer data from the source indicated by the first source register by using the first buffer as a relay,
and wherein said second channel unit includes:
a second buffer,
a second source register to indicate an access position where a source is accessed;
a second destination register to indicate an access position where a destination is accessed, said second channel unit configured to transfer data from the source indicated by the second source register by using the second buffer as a relay, said first channel unit and said second channel unit cooperating in such a manner that reading of data from a given source to the first buffer is performed concurrently with writing of data from the second buffer to a given destination, and that reading of data from the given source to the second buffer is performed concurrently with writing of data from the first buffer to the given destination.

10. A data transfer apparatus, comprising
a plurality of buffers;
a first channel unit including a first queue to store information items for identifying buffers in sequence; and
a second channel unit including a second queue to store information items for identifying buffers in sequence,
said first channel unit operable to successively select available buffers from said plurality of buffers to successively store information items for identifying the selected buffers in the first queue, and reading of data from a source to a buffer indicated by a last information item in the queue being performed concurrently with writing of data from a buffer indicated by a first information item in the queue to a destination.
